(19) United States
(12) Patent Application Publication
(10) Pub. No.: US 2012/0325572 A1
(43) Pub. Date: Dec. 27, 2012

(54) Combination Parking Brake-Seat Belt Minder

(76) Inventor: Joseph Morgese, Daytona Beach, FL (US)

(21) Appl. No.: 13/482,084

(22) Filed: May 29, 2012

Related U.S. Application Data
(60) Provisional application No. 61/491,012, filed on May 27, 2011.
(60) Provisional application No. 61/508,653, filed on Jul. 17, 2011.
(60) Provisional application No. 61/514,919, filed on Aug. 4, 2011.

(51) Int. Cl. B60R 21/00

(52) U.S. Cl. 180/268

(57) ABSTRACT

A combination of two devices providing a method for ascertaining that the parking brakes of a vehicle are applied whenever the driver leaves the driver's seat and that the driver is always wearing their seat belt whenever the vehicle is rolling. One embodiment of a seat belt restrictor assembly (40) interconnected by means of electronic communication circuit (56) to a choice of one of the many embodiments of the parking brake restrictor assemblies (60, 74, 90, 100) presented here, whereby, the driver cannot disengage the parking brakes until the seat belt is fastened, and the driver cannot unfasten the seat belt until the parking brakes are engaged. Other important safety and security functions may also be enforced by connecting to these two devices, such as, password technology which allows control over who drives the vehicle, battery-drain monitoring, and wireless cell-phone and text scrambling.

### CROSS-REFERENCE TO RELATED APPLICATIONS

This application claims the benefit of provisional patent application No. 61/491,012, filed on May 27, 2011, provisional patent application No. 61/508,653 filed on Jul. 17, 2011, and provisional patent application No. 61/514,919, filed on Aug. 4, 2011; all were filed by present inventor.

### BACKGROUND

1. Field of Invention

The ‘Combination Parking Brake-Seat Belt Minder’ caters to public safety and security with regards to vehicle handling responsibilities. Specifically, several embodiments of this invention, by virtue of electronic communication between the various parts, can enforce the use of certain important functions, if so desired, for example, but not limited to:
driver's seat belt
parking brakes
password controls
accepted vehicle ignition
driver's sobriety
battery protection
means for inhibiting wireless usage while driving
future technological advancements may allow for inclusion of other functions

2. Prior Art

The background of the ‘Combination Parking Brake-Seat Belt Minder’ grew from a need to remind drivers to engage their parking brakes when they are exiting their vehicles.

Although most standard-shift four wheel vehicles are also subject to the problems that forgetting to engage parking brakes could cause, I, myself, having been a commercial truck driver for fifteen years and on several occasions, I have witnessed the damaging effects caused by a driver's forgetting to engage the parking brakes of their commercial vehicle, as well as many close calls!

The reason why this is so is because, even though we had been taught in truck-driver training school to park the truck in gear and wheel chocks as added security measures, and further, the truck does have a system of dashboard lights and buzzers that go on whenever the parking brakes are not engaged, it still does not, on occasion, prevent the mishap of an uncontrolled rolling vehicle and the possible harm to life, limb and property that such an event can cause. A driver enters and exits the vehicle many times during the day, and it remains a quite likely possibility that a driver may be distracted for whatever reason and it only takes a moment of forgetfulness for this event to occur.

Many examples can now be found on you-tube videos, thanks to the ubiquitous installation of parking security cameras, where one can see driver-less vehicles rolling towards a Russian-roulette of dire consequences.

Beyond the system of dashboard lights and buzzers that come on whenever the drivers seat belt is not fastened or the parking brakes are not applied, there remains little defense against the occasional mishap of forgetting to use these important functions.

Furthermore, although the start of this invention started from a desire to fill the need for a better solution towards the aforementioned parking brake issue, it soon became evident that other important vehicular security and safety issues would also be handled by one or more aspects of this invention.

### SUMMARY

The essence of the ‘Combination Parking Brake-Seat Belt Minder’ is the feeling of certainty and the peace of mind it provides. The cost is modest relative to the safety and security benefits enjoyed. As well, the driver does not have to do or remember any new tasks as these are all part of the routine tasks already being done.

Thus, the vehicle cannot be driven without the driver's seat belt being fastened and the driver cannot get up off the driver's seat without the parking brakes being engaged. Furthermore, many other functions can be monitored and enforced if so desired by using one or more aspects of several of the embodiments.

Listed in the next segment are several advantages.

### Advantages

Thus several advantages of the one or more aspects of this invention are that element of certainty that is brought into play whenever handling vehicular responsibilities. A certainty which fosters peace of mind for all of the stakeholders, by providing:
a means of assuring that the parking brake is always being used whenever the vehicle is parked
a means of assuring that the seat belt is always being worn by the driver whenever the vehicle is moving
a means of assuring that only authorized drivers gain access through password control
a means of accepting only recognized ignition protocol is being used thus preventing vehicle theft
a means of assuring that the driver of the vehicle is sober whenever driving the vehicle
a means of assuring that the vehicle's electrical systems are turned off and not draining the battery when vehicle is parked
a means of wireless technology inhibition is engaged thus preventing cell phone and texting usage while driving

Other benefits include:
Several embodiments of one or more aspects of this invention are geared for the aftermarket with a very economical, relative to the safety and security benefits.
The driver is not asked to do any extra tasks beyond those already being done.

All these and other advantages will become apparent from a consideration of the ensuing description and accompanying drawings.

### DRAWINGS

### Drawings for the First Embodiment

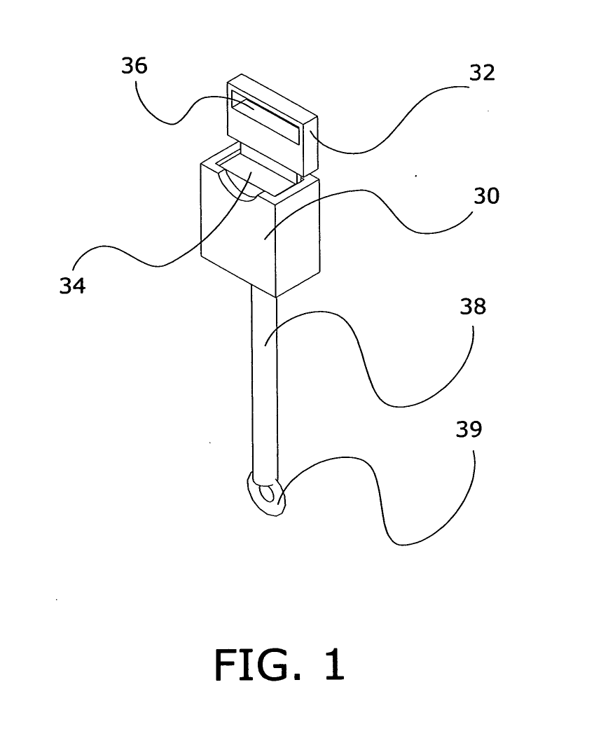

FIG. 1 shows the isometric drawing of a common seat belt buckle.

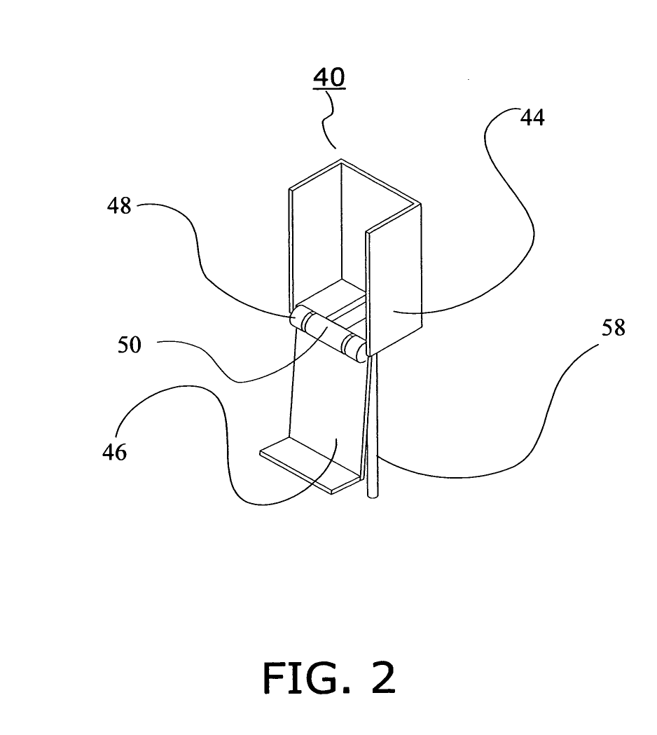

FIG. 2 shows the isometric drawing of the seat belt restrictor assembly.

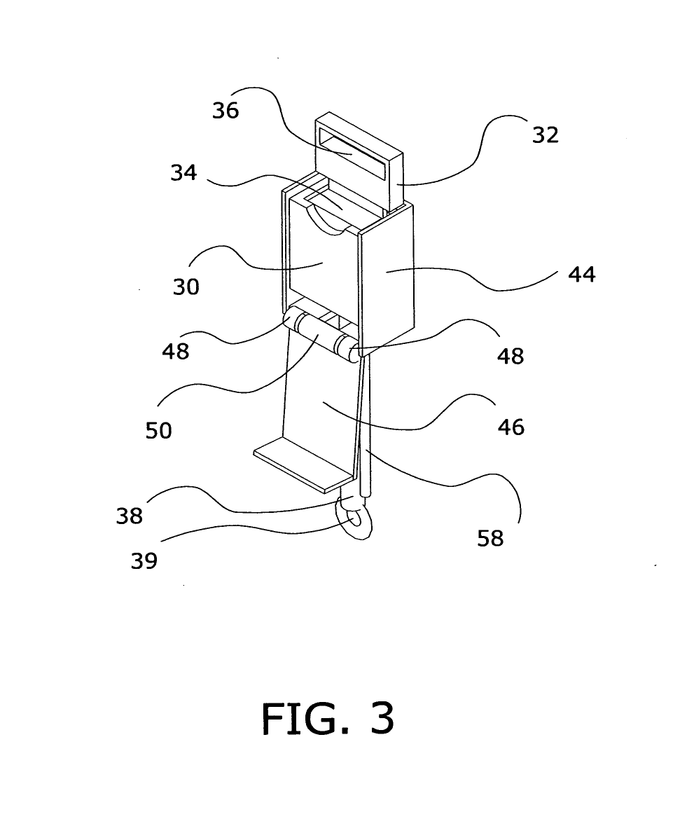

FIG. 3 shows the isometric drawing of the seat belt buckle being totally enclosed by the restrictor housing with the gate opened.

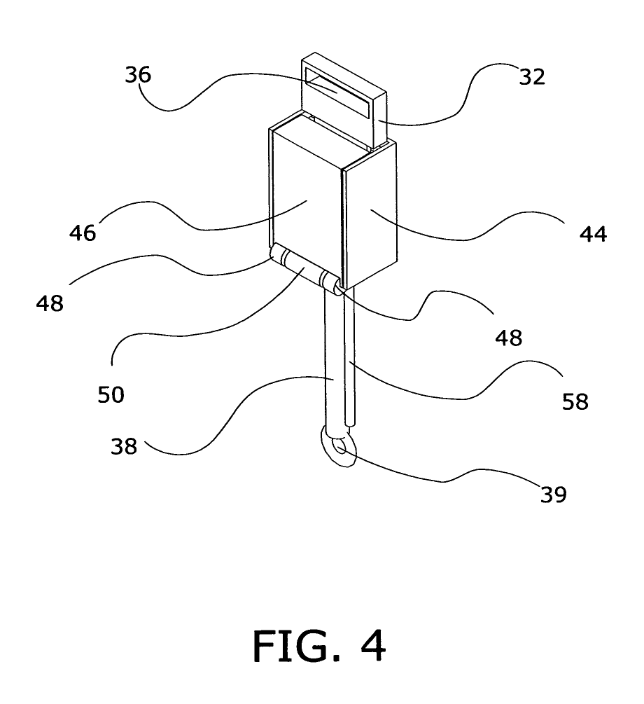

FIG. 4 shows the isometric drawing of the seat belt buckle being totally enclosed by the restrictor housing with the gate closed.

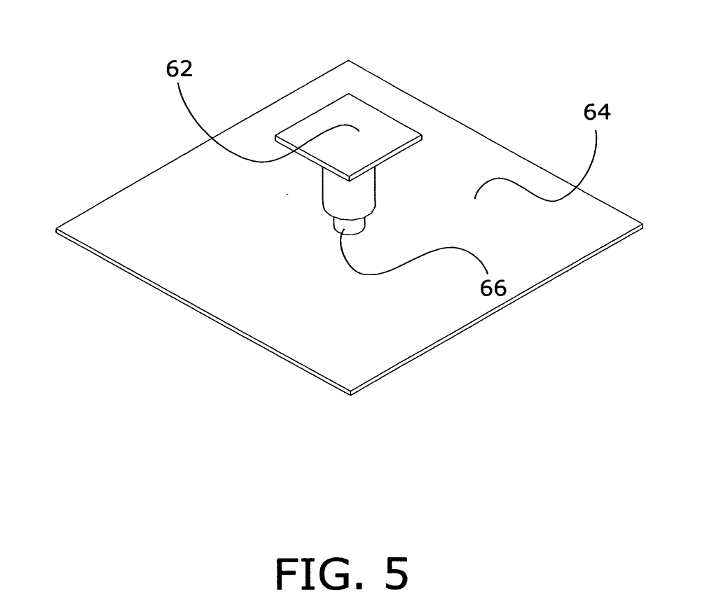

FIG. 5 shows the isometric drawing of a parking brake knob (or air brake knob) of a common commercial vehicle application, where the knob is being shown as pulled back from the dashboard, as it would be if the parking brakes were engaged.

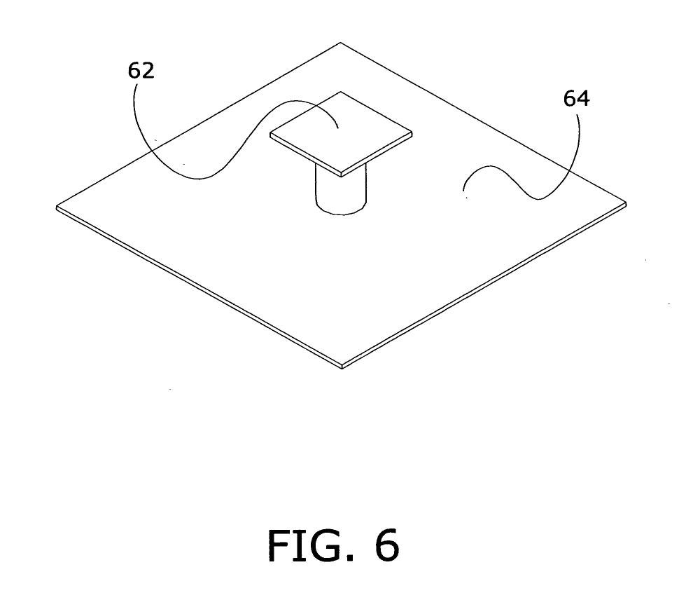

FIG. 6 shows the isometric drawing of a that same parking brake knob, where the knob is now being shown as pushed in towards the dashboard, as it would be if the parking brakes were disengaged.

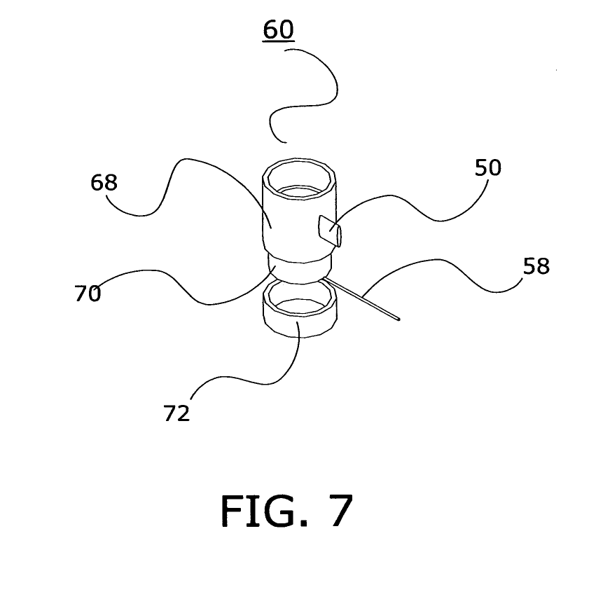

FIG. 7 shows a close-up isometric of the external modification collapsible collar of the first embodiment of the invention.

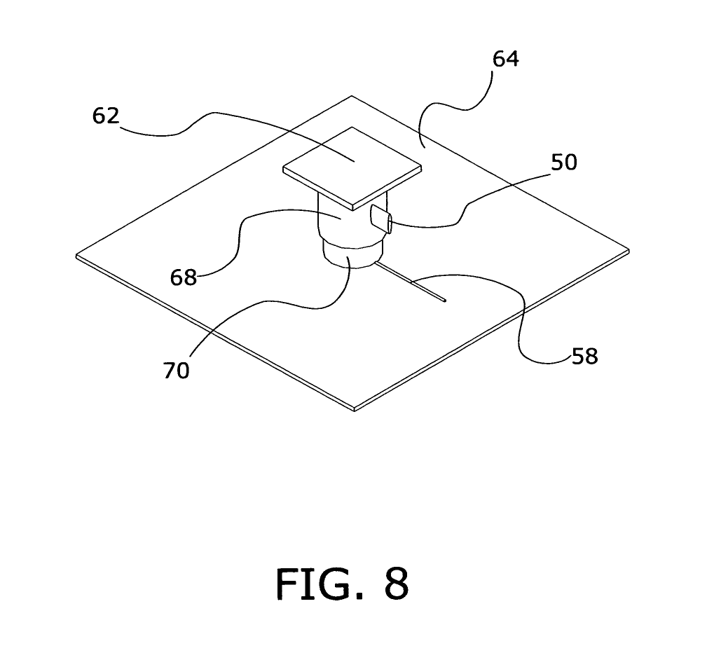

FIG. 8 shows the collar installed on the parking brake knob without the spring coil so as to display the inner collar.

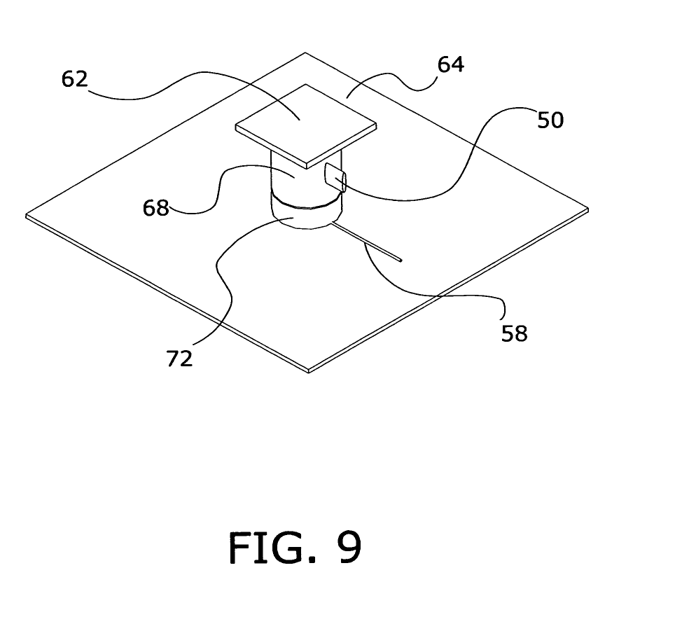

FIG. 9 shows the collar with the spring coil showing and the inner collar hidden from view.

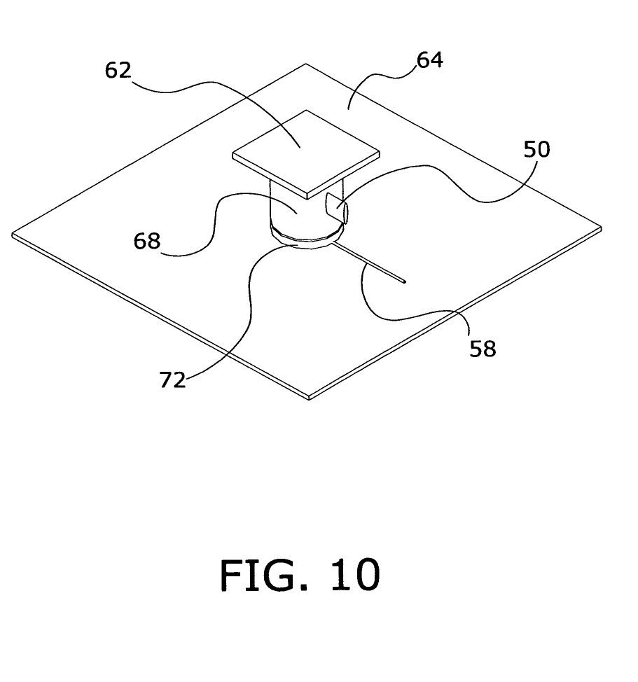

FIG. 10 shows the collar now with the parking brake knob being pushed towards the dashboard, as it would be if the parking brakes were disengaged.

### Drawings for the Second Embodiment

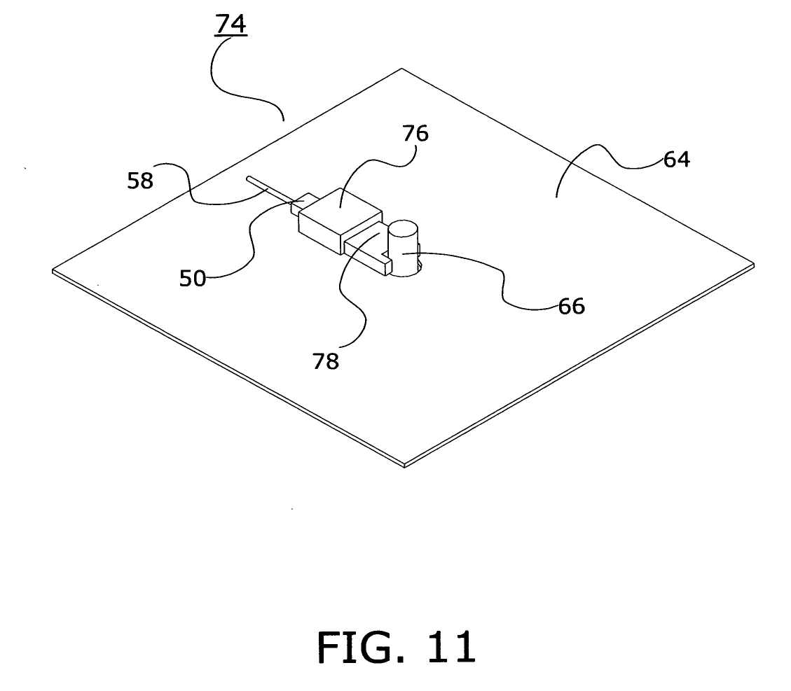

FIG. 11 shows an isometric drawing of the external modification dashboard restrictor assembly of the second embodiment without the parking brake knob for a better view.

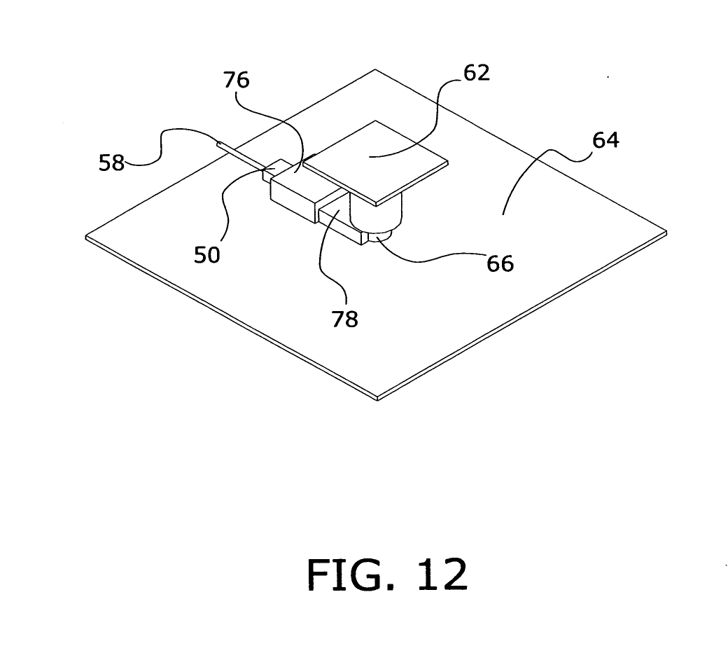

FIG. 12 shows the dashboard restrictor the parking brake knob pulled away from the dashboard.

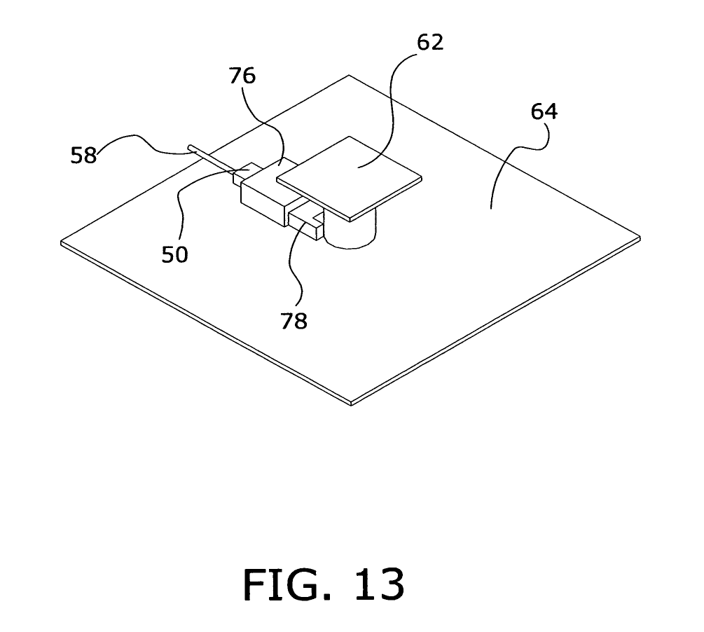

FIG. 13 shows the dashboard restrictor with the parking brake knob pushed in towards the dashboard.

### Drawings for the Third Embodiment

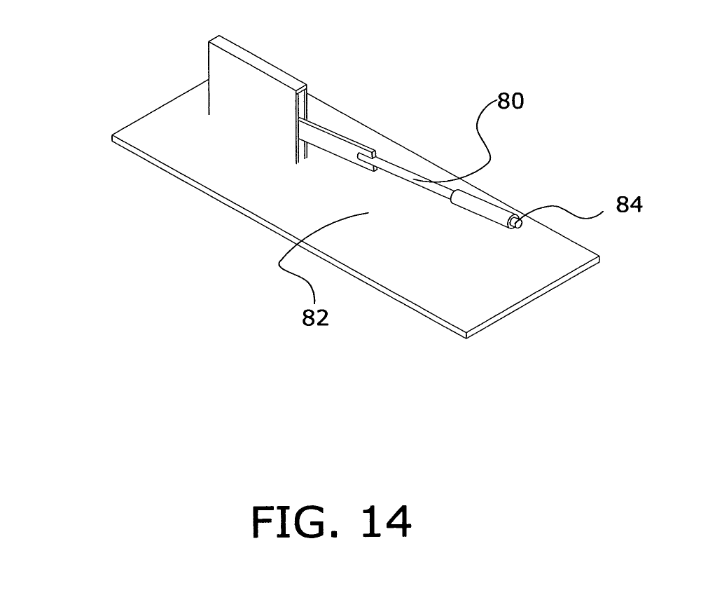

FIG. 14 shows an isometric drawing of a parking brake lever or handle that is commonly found in four wheel standard shift transmission vehicles and is shown here in the drawn-up position as it would be if the parking brakes were engaged.

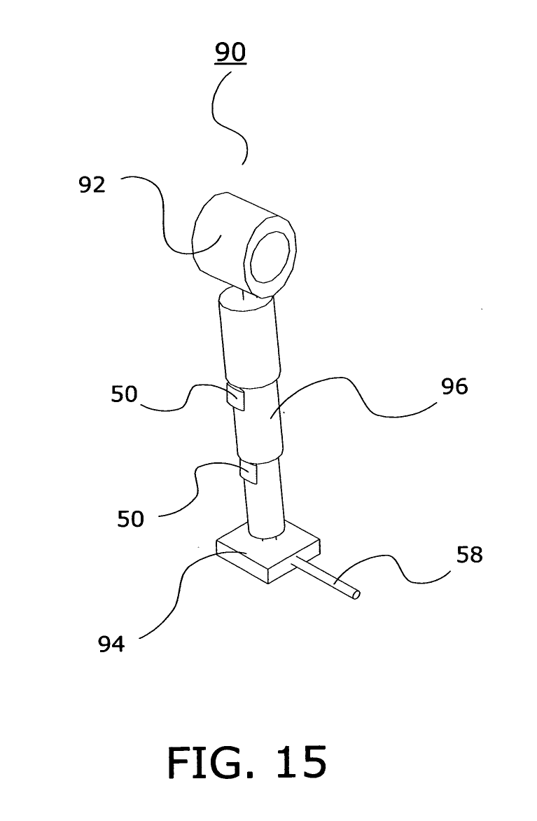

FIG. 15 shows a close-up of the third embodiment telescopic restrictor in an expanded mode as would be found when the parking brake handle is in the drawn-up position.

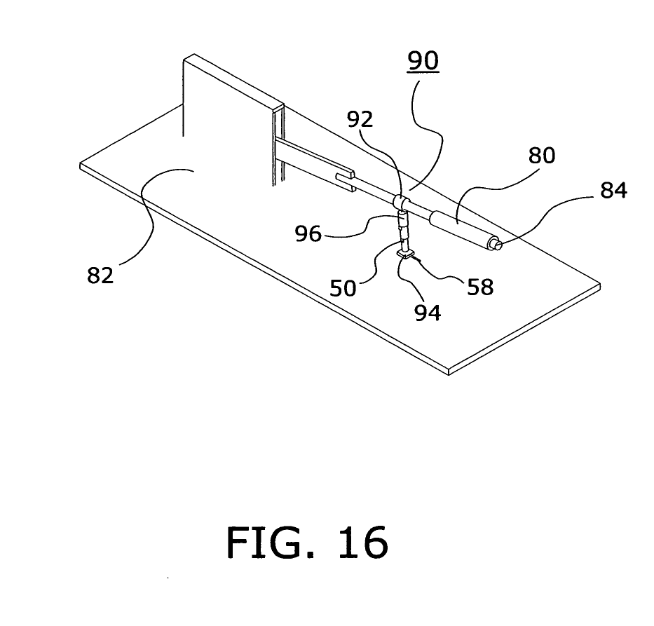

FIG. 16 shows the parking brake lever in a drawn-up position and the telescopic restrictor installed with one end fastened at the handle and the other end fastened onto the console.

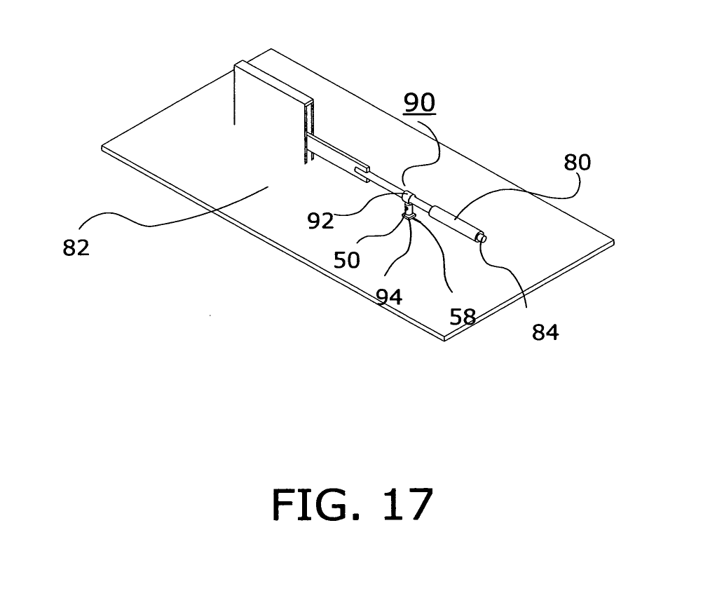

FIG. 17 shows the parking brake handle in a drawn-down position for disengaging the parking brakes of the vehicle and with the telescopic restrictor being made compacted.

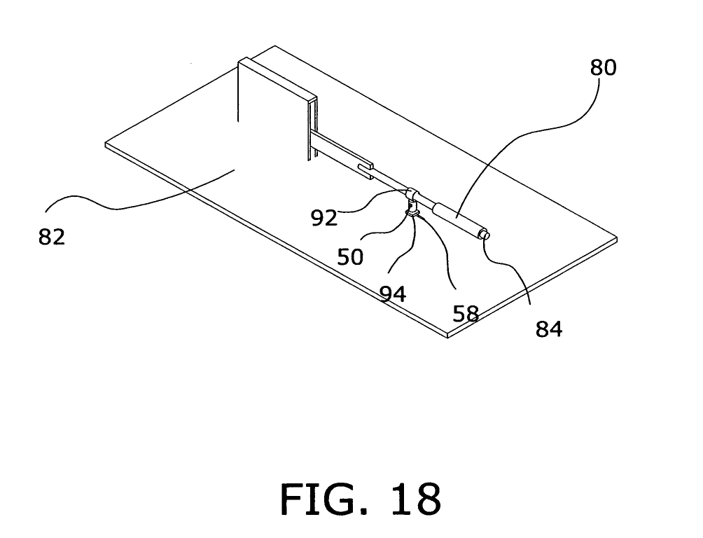

FIG. 18 shows a close up side view of the telescopic restrictor in compacted mode as would be found when the parking brake handle is in the drawn-down position.

### Drawings for the Fourth Embodiment

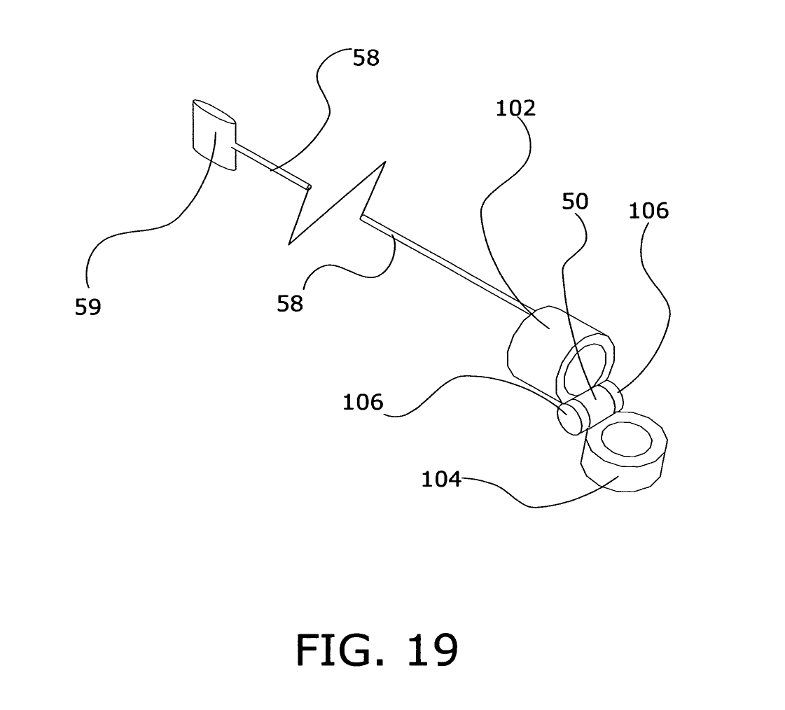

FIG. 19 shows a close-up isometric drawing of the fourth embodiment release button restrictor assembly.

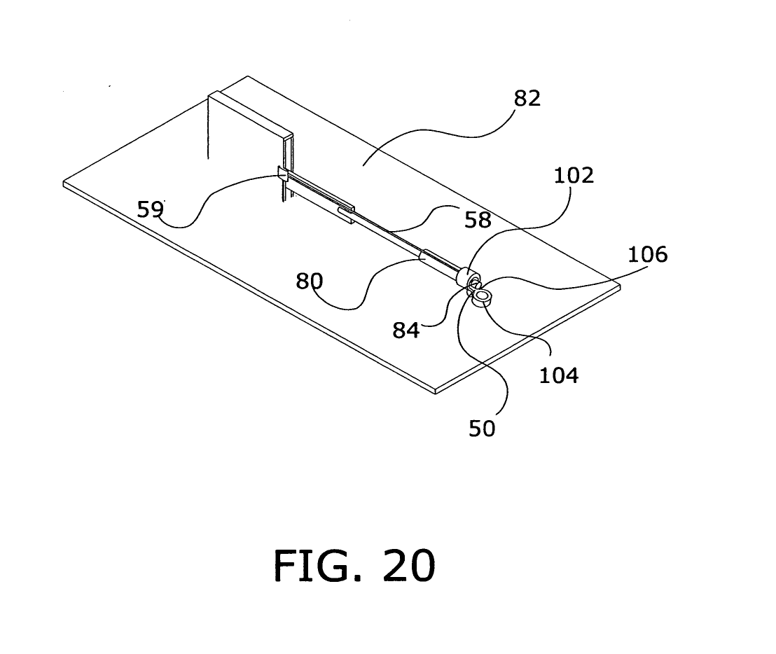

FIG. 20 shows an isometric drawing of the parking brake handle in a drawn-down position and with the release button restrictor assembly installed in an open flip-cap mode.

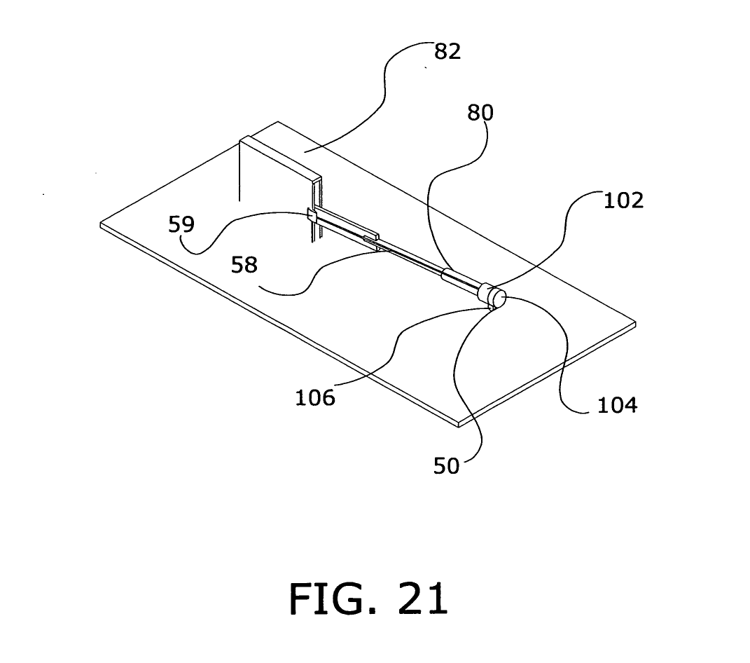

FIG. 21 now shows the parking brake handle in a drawn-up position and with the release button restrictor assembly installed in a closed flip-cap mode.

### Drawings of an Electrical Actuator

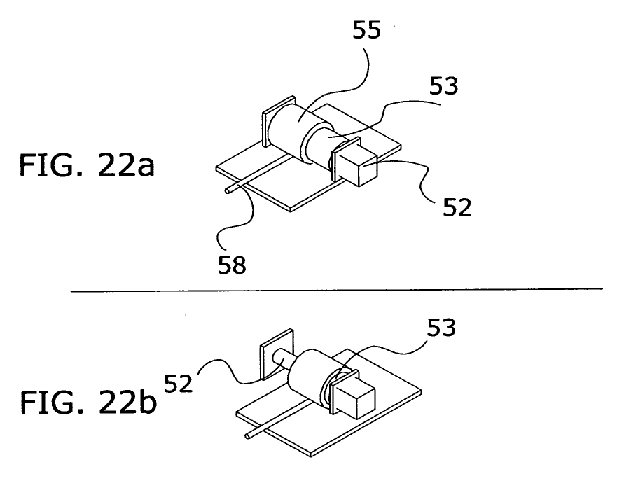

FIG. 22a shows an isometric drawing of an electrical actuator in the off position.

FIG. 22b shows the same actuator in the on position.

### REFERENCE NUMERALS

30—seat belt buckle
32—seat belt clip
34—clip release button
36—clip seat belt opening
38—flexible extension rod
39—buckle assembly bolt hole
40—seat belt restrictor assembly
44—seat belt restrictor housing
46—gate
48—gate hinge
50—electronic actuator assembly
52—actuator pin
53—actuator spring
55—electro-magnet
56—communication electrical loop and contacts
58—electric wiring
59—angle-monitoring contact for park
60—parking brake knob restrictor collapsible collar assembly
62—parking brake knob
64—dashboard
66—air-brake stem
68—outer collar
70—inner collar
72—spring coil for collar
74—dashboard restrictor assembly
76—restrictor housing
78—restrictor fork
80—parking brake lever handle
82—console of vehicle
84—release button of parking handle
90—telescopic restrictor assembly
92—brake handle grip of telescopic restrictor
94—console grip of telescopic restrictor
96—telescopic restrictor plurality of tubes
100—release button restrictor assembly
102—handle grip of the release button restrictor
104—flip-cap of release button restrictor
106—flip-cap hinge

### THE DRAWINGS AND THE DESCRIBED OPERATIONS

Even though FIGS. 22a and 22b are the last drawings, I choose to introduce them here at the beginning because the devices (of all of the embodiments presented) use this electronic actuator for function control. I also cover the electronic communication circuit in this segment. I feel that teaching the operation of the actuator and circuit here will greatly simplify the readers understanding of the remainder of the drawings and my description and operations thereof.

Those that may already know and understand these workings may skip this segment and proceed to FIG. 1 below.

### The Actuator of FIGS. 22a and 22b

FIGS. 22a and 22b show the function of an actuator 50. Actuator 50 is shown in the two possible positions. The upper drawing 22a shows the off position and the lower drawing 22b shows the on position.

In the off position, an actuator pin 52 is shown protruding towards the right. The square end of pin 52 is placed in such a position as to be inserted within the orifice of an adjacent object. This is done for the purpose of controlling the object by locking it in place.

An electro-magnet 55 is turned off. A coil spring 53 keeps pin 52 pressed within the orifice of the object being controlled. An electrical wiring 58 is connecting the electro-magnet 55 to the power source of the vehicle. Wiring 58 is also connecting the electro-magnet 55 to an electrical communication circuit 56 which is linked with various other devices. This circuit 56 will send electric current to electro-magnet 55 when a certain criteria or plurality thereof are met.

For example, if the seat belt is being fastened, it would dose a contact within circuit 56 at buckle 30. As a result, it would send electrical charge to electro-magnet 55 causing a surge of magnetism. This magnetism pulls pin 52 towards the left, as is shown in the ‘on’ position drawing.

Pin 52 is pulled away from the orifice of the object being controlled. This action unlocks the object thus allowing free movement of that object towards a desired objective.

At this point, the electrical charge is finished and electro-magnet 55 is off; however, pin 52 is no longer in the orifice of the object being controlled. Spring 53 is compressed and is exerting pressure upon pin 52 to go back towards the right. Pin 52 is now pressed against the outer surface of that object and waiting for the opportunity to re-align with the orifice when the object returns to its original locking position. Once that occurs, pin 52 enters the orifice and the object is now locked again.

### Actuator Ubiquity

Actuators are found in every aspect of our day to day living. They provide remote control capabilities for doors and latches. They are being used very copiously in vehicle control systems as well.

There is an actuator in all of the embodiments of both the seat belt restrictor and the parking brake restrictors being presented below.

### The Electronic Circuit

The electronic circuit consists of an electrical wiring circuit, switches and contacts. The contacts connect to the various devices that are objects of control for a desired effect.

For example, as in the case of the seat belt usage, there would be one contact in buckle 30, which whenever clip 32 is inserted, would cause the contact to close. This event would allow electricity into circuit 56 that is wired 58 up to actuator 50 at restrictor 60 of the parking brake. This would signal actuator 50 to allow the restrictor 60 to unlock thereby incapacitating the restrictor means. This in turn would allow the driver to disengage the parking brakes.

Also, for example, as in the case of the parking brake usage, the parking brake would have a contact as well and when the parking brakes would be engaged, a contact at the parking brake would close. This event would allow electricity into circuit 56 that is wired 58 up to actuator 50 at restrictor 40 of the seat belt. This would signal actuator 50 at restrictor 40 and allow it to unlock thereby incapacitating the restrictor means. This in turn would allow the driver to unfasten the seat belt.

There is an electrical communication circuit in all of the embodiments of both the seat belt restrictor and the parking brake restrictors being presented below. This would also be the means for communicating with any other object of control for a desired effect.

### The First Embodiment

### Detailed Description of the First Embodiment

### Drawings for the Seat Belt Buckle Restrictor Device

FIGS. 1 through 4

### FIG. 1

FIG. 1 shows the isometric drawing of a common seat belt buckle 30 without any externally added modifications of this first embodiment of this invention. The particular model that is being illustrated in this drawing would be what is commonly found in commercial vehicle applications. Nonetheless, the various parts and functions remain the same as used by all vehicles. A seat belt restrictor device 40 will apply to all seat belt variations with only modest design adjustments.

Buckle 30 of FIG. 1 shows a seat belt clip 32 inserted. A seat belt would be threaded through a seat belt clip opening 36. One would push on a clip release button 34 to unfasten the seat belt. A flexible rod 38 helps bring buckle 30 within easy reach for the driver. Buckle 30's assembly is fastened to a driver's seat frame with a bolt through a bolt hole 39.

### FIG. 2

FIG. 2 shows a close-up isometric view of seat belt restrictor 40 not yet installed on buckle 30. There is a seat belt buckle housing 44, a gate 46, a couple of gate hinges 48, an electronic actuator 50, and an electrical wiring 58.

### FIG. 3

FIG. 3 now shows buckle 30 being affixed to seat belt restrictor 40. Buckle 30 is nestled within housing 44. Gate 46 is connecting to housing 44 with hinges 48. This embodiment shows actuator 50 being situated at area of hinge 48. Wiring 58 runs up along rod 38 and it connects to actuator 50. Rod 38 is fastened to the driver's seat at bolt hole 39.

Clip 32 is shown inserted into buckle 30. Opening 36 at clip 32 is where the seat belt runs through clip 32. Clip release button 34 is situated on buckle 30, right next to clip 32.

### FIG. 4

FIG. 4 shows gate 46 enclosing over buckle 30. However, clip 32, which holds the seat belt at opening 36, still has access to buckle 30. Actuator 50 locks gate 46 closed at the of area hinge 48. Gate 46 is closed within housing 44 to form a box around buckle 30. Rod 38 is shown connecting bolt hole 39 with the now enclosed buckle 30. Wiring 58 runs along rod 38 and connects to actuator 50.

### Detailed Description of the First Embodiment

### Drawings for the Parking Brake Restrictor Device

### Version of the First Embodiment

FIGS. 5 through 10

### FIG. 5

FIG. 5 shows the drawing of a parking brake knob (or air brake knob) 62 as commonly found in a commercial vehicle. An air brake stem 66 protrudes through a dashboard 64 and screws into knob 62. Knob 62 is pulled back from dashboard 64 indicating that the parking brakes of the vehicle are engaged.

### FIG. 6

FIG. 6 shows knob 62 being pushed in towards dashboard 64 indicating that the parking brakes of the vehicle are disengaged.

### FIG. 7

FIG. 7 shows a close-up isometric drawing of the first embodiment parking brake restrictor device called the collapsible collar 60. An outer collar 68 contains an inner collar 70. A spring coil 72 is offset in this drawing to show inner collar 70. An electronic actuator 50 is attached to collapsible collar 60. An electrical wiring 58 connects actuator 50 to the electrical system of the vehicle and to an electrical communication circuit 56.

### FIG. 8

FIG. 8 shows collapsible collar 60 being inserted around the neck of knob 62. Knob 62 is pulled back away from dashboard 64. Outer collar 68 and inner collar 70 are shown with spring 72 being left out for illustration purposes. Actuator 50 and wiring 58 complete this drawing.

### FIG. 9

FIG. 9 shows collapsible collar 60 being inserted around the neck of knob 62. Knob 62 is pulled back away from dashboard 64. Spring 72 is joined to inner collar 70 at the end which rests upon dashboard 64. Inner collar 70 is hidden from view by spring 72 but we can see outer collar 68 pressing against spring 72. Actuator 50 and wiring 58 complete this drawing.

### FIG. 10

FIG. 10 shows collapsible collar 60 with knob 62 now being pushed towards dashboard 64, as it would be if the parking brakes were disengaged. Outer collar 68 is compressed against spring 72. Wiring 58 connects to actuator 50.

### Operation of the First Embodiment

### Preface

The first embodiment of this invention showcases two devices. One devise is attached to buckle 30 and serves to control the use of the seat belt, and the other device is attached to knob 62 and serves to control the use of the parking brakes. Both of these devices communicate electronically with each other.

The desired effect that comes by use of this invention is that, 1—the driver of the vehicle cannot disengage the parking brakes without first fastening his/her seat belt and 2—the driver cannot unfasten his/her seat belt without first engaging the parking brake.

As a result of this combination, the vehicle can never roll without the driver's wearing his/her seat belt, which is the law of the land to do so. Furthermore, the driver can never forget to engage the parking brake whenever he/she wants to get up off of the driver's seat. All of the stakeholders, who could be concerned, would want to be sure of this occurring.

### A Demonstration

The operation of this first embodiment of the ‘Combination Parking Brake-Seat Belt Minder’ goes like this.

The driver of the vehicle enters the vehicle, starts the motor and reaches for knob 62 and pushes it towards dashboard 64 in order to disengage the parking brakes.

However, it will not budge and the driver realizes that he/she forgot to fasten his/her seat belt. Knob 62 will not disengage the parking brakes until the driver has fastened his/her seat belt.

Once the seat belt is fastened however, knob 62 is unlocked and this allows the driver to disengage the parking brakes and get the vehicle rolling. Later, when the driver wants to get up off of his/her seat, he/she will seek to unfasten his/her seat belt by pushing clip release button 34 at buckle 30.

However, he/she soon realizes that he/she cannot unfasten the seat belt until the parking brakes have been engaged. Therefore, he/she reaches over to knob 62 and pulls it away from dashboard 64 thus engaging the parking brakes. This in turn allows the driver to now unfasten the seat belt and get up off the seat.

The devices that will make this possible are presented in the following pages. Each embodiment, in their own way, accomplishes this effect for both of the aforementioned functions as well as any other function that may be chosen to be enforced.

### The Seat Belt Restrictor Device of the First Embodiment

FIGS. 1 through 4

### FIG. 1

FIG. 1 shows buckle 30 as would be found in most commercial vehicles. All seat belt buckles are constructed in a very similar fashion with only minor variations between the different models available.

Clip 32 is shown inserted into buckle 30 as it would be if the driver's seat belt was fastened. Opening 36 located in clip 32 is where the seat belt is threaded through thus enabling clip 32 to keep the seat belt wrapped around the driver's torso.

Buckle 30 also contains clip release button 34 which the driver would push on to unfasten the seat belt. Rod 38 has bolt hole 39 at the bottom where a bolt attaches buckle 30′s assembly to the driver's seat.

### FIGS. 2,3 and 4

FIG. 2 shows the close-up of seat belt restrictor 40.

FIG. 3 shows housing 44 holding buckle 30 affixed within it. When the driver fastens his/her seat belt, he/she closes gate 46 over buckle 30 in order to be able to disengage the parking brakes.

FIG. 4 shows how gate 46 closes over buckle 30. Actuator 50 is located at the area of hinge 48. Actuator 50 keeps gate 46 locked over button 34, which in turn, will prevent the driver from unfastening the seat belt.

Actuator 50 will release locked gate 46 as soon as certain desired events have occurred. This function can be applied to a plurality of desired events, such as, for example, all of the lights of the vehicle being turned off to conserve the battery power; however, the desired event of this embodiment will focus solely on enforcing the engagement of the parking brakes.

Wiring 58 connects actuator 50 to the power source of the vehicle and circuit 56 that is connected with the parking brake, so that, only after the driver has engaged the parking brakes, will he/she be able to unfasten the seat belt.

### The Parking Brake Restrictor Device of the First Embodiment

### FIGS. 5 and 6

FIGS. 5 and 6 show knob 62 at dashboard 64 as it is commonly found in commercial vehicles. In FIG. 5, knob 62 is pulled away from dashboard 64 indicating that the parking brakes of the vehicle are engaged. In FIG. 6, knob 62 is pushed in against dashboard 64, indicating that the parking brakes of the vehicle are disengaged.

A slight opening at dashboard 64 of FIG. 5 allows us to see stem 66. Knob 62 is screwed onto stem 66. It will be a simple installation when we set out to install collapsible collar 60 of FIG. 7.

### FIG. 7

FIG. 7 shows a close-up isometric drawing of the first embodiment's collapsible collar 60. Outer collar 68 slides over inner collar 70 to allow for a combined result of the two necessary dimensions of length. One dimension of length is for locking knob 62 in the parking brake's engaged position and the other is for accommodating knob 62 when it is at the parking brake's disengaged position.

Actuator 50 keeps collapsible collar 60 locked at the engaged position which prevents knob 62 from being pushed in to disengage the parking brakes. Wiring 58 gives actuator 50 both the electrical vehicle source power and needed communication of circuit 56 to act when the time comes.

Spring 72 is shown offset here to allow for seeing inner collar 70 which would be normally hidden from view.

### FIGS. 8, 9 and 10

Collapsible collar 60 is inserted at the neck of knob 62 by simply unscrewing knob 62 from stem 66, slipping on device 60 and re-screwing knob 62 back onto stem 66. Knob 62 of FIGS. 8 and 9 are shown in a pulled back position from dashboard 64 indicating that the parking brakes are engaged.

FIG. 8 shows inner collar 70 without spring 72, that would normally cover it; however, FIG. 9 shows spring 72 as it would normally be and this time, with inner collar 70 beneath it and out of view. Spring 72 keeps collapsible collar 60 fitting tightly between dashboard 64 and the underside of knob 62′s head. Inner collar 70 and spring 72 are joined at dashboard 64.

FIG. 10 shows knob 62 as being pushed in against dashboard 64 indicating that the parking brakes are disengaged.

Spring 72 of FIG. 10 is compressed and is exerting pressure on outer collar 68 to slide up inner collar 70 as soon as the driver pulls on knob 62 in order to engage the brakes. When this happens, spring 72 will expand and collapsible collar 60 will return to its original locking dimension.

As was described in FIG. 22, actuator pin 52 will align with an orifice within collapsible collar 60 and insert back into it. This will lock outer collar 68 and inner collar 70 at a fixed dimension designed to keep the parking brake from being pushed in.

Collapsible collar 60 as well as any of the embodiments presented can be made of any hardened material comprising of but not limited to metals, plastics or fiberglass.

### The Second Embodiment

### Detailed Description of the Second Embodiment

### The Parking Brake Restrictor Device of the Second Embodiment

FIGS. 11 through 13

FIG. 11 shows the Dashboard Restrictor Device Assembly 74 where a housing 76 is attached to dashboard 64 next to stem 66. Knob 62 is temporarily removed to allow a better view of a resistor fork 78 being locked against stem 66. An electronic actuator 50 is shown at the opposite end of housing 76 from fork 78. An electric wire 58 is connected to actuator 50.

FIG. 12 now shows knob 62 being pulled back from dashboard 64 indicating that the parking brakes are engaged. Fork 78 is locked against stem 66 and knob 62 is positioned atop the surface of fork 78. Housing 76 contains actuator 50. Wiring 58 connects to actuator 50.

FIG. 13 shows knob 62 as pushed in against dashboard 64. Fork 78 is retracted into housing 76. Actuator spring 53 of actuator 50 keeps fork 78 pressed against knob 62. Wiring 58 completes the drawing.

### Operation of the Parking Brake Restrictor Device of the Second Embodiment

FIGS. 11 through 13

FIGS. 11, 12 and 13 showcases another embodiment called the dashboard restrictor assembly 74. It is an alternate method for restricting knob 62 and all of the operation description of the first embodiment applies to this second embodiment except that collapsible collar 60 of the first embodiment is replaced by dashboard restrictor 74. However, it accomplishes the same restrictive means as the first embodiment.

In FIG. 11, knob 62 has been temporarily removed from the drawing so as to allow for a better view of fork 78.

Dashboard restrictor 74 installs right up against dashboard 64, next to knob 62. FIG. 12 shows knob 62 being pulled back away from dashboard 64 and dashboard restrictor 74 locks fork 78 up against stem 66 that protrudes from behind dashboard 64. Fork 78 of this embodiment extends towards and wraps around stem 66 in a semi circular manner.

Housing 76 is fastened against dashboard 64 and fork 78 moves in and out of housing 76 as needed to either restrict knob 62 from being pushed in against dashboard 64 or retract and allow free movement of knob 62.

Actuator 50 is shown at the opposite end of housing 76 from fork 78. Wiring 58 is shown connecting to it. Actuator pin 52 moves fork 78 towards knob 62 to restrict its being pushed in against dashboard 64. Actuator pin 52 also pulls fork 78 away from knob 62 to allow knob 62 to be pushed up against dashboard 64.

FIG. 13 shows dashboard restrictor 74 in a contracted mode which allows knob 62 free movement. Actuator spring 53 keeps fork 78 pressed against knob 62 and will slip back in against stem 66 as soon as the driver pulls knob 62 away from dashboard 64.

### The Third Embodiment

### Detailed Description of the Third Embodiment

### The Parking Brake Restrictor Device of the Third Embodiment

FIGS. 14 through 18

### FIG. 14

FIG. 14 shows an isometric drawing of a parking brake lever handle 80. It is set upon a console 82. A handle release button 84 is at the end of the handle. This style of parking brake lever handle is commonly found in most four wheel standard shift transmission vehicles.

This isometric drawing shows handle 80 in a drawn-up position indicating that the parking brakes of the vehicle are engaged. Both the third and fourth embodiments of the parking brake restrictor device will be designed for this style of parking brake handle lever.

### FIG. 15

FIG. 15 shows a close-up isometric drawing of a telescopic restrictor assembly 90. A plurality of telescopic tubes 96 is expanded. There is a pair of electronic actuators 50 in this particular embodiment. An electrical wiring 58 connects through a console grip 94. A brake handle grip 92 connects to handle 80.

### FIG. 16

FIG. 16 now shows handle 80 in a drawn-up position. Telescopic restrictor 90 is attached to handle 80 with handle grip 92 at the top of telescopic restrictor 90 and is attached to console 82 with console grip 94 at the bottom of telescopic restrictor 90. Tubes 96 are expanded and locked in this position with two actuators 50. Wiring 58 connects to actuators 50. Handle release button 84 of handle 80 completes the drawing.

### FIG. 17

FIG. 17 now shows handle 80 in a drawn-down position. Telescopic restrictor 90 is compacted. Console 82, console grip 94, handle release button 84, handle grip 92, wiring 58 and actuator 50 complete the drawing.

### FIG. 18

FIG. 18 shows a close-up side-view drawing of telescopic restrictor 90 in a compacted position. Handle lever 80 is in a drawn-down position. Tubes 96 is compacted. Console 82, handle grip 92, console grip 94, wiring 58 and actuator 50 complete the drawing.

### Operation of the Parking Brake Restrictor Device of the Third Embodiment

FIGS. 14 through 18

The operation of the third embodiment of the ‘Combination Parking Brake-Seat Belt Minder’ works exactly the same as that of the first and second embodiment except that the modification is now being applied to handle 80 as is commonly found on four wheel standard shift transmission vehicles.

Whereas in the first and second embodiments, where the driver pushes knob 62 against dashboard 64 in order to disengage the parking brakes of the vehicle, and then pulls on knob 62 to engage the parking brakes, and the collapsible collar 60 and/or the dashboard 74 are positioned in such a way as to restrict this, in this embodiment, handle 80 is controlled by restricting its upward and downward motion. The telescopic restrictor 90 prevents handle 80 from being moved.

Telescopic restrictor 90 is fastened at handle grip 92 to handle 80 and at console grip 94 to console 82 of the vehicle. Actuators 50 are situated in tubes 96 and keep them locked at the needed dimension until the driver fastens his/her seat belt. Once done, actuators 50 release tubes 96 for free movement. This allows tubes 96 to collapse and handle 80 can now come down so as to disengage the parking brakes of the vehicle.

There may be a plurality of tubes and actuators in a telescopic restrictor style device. This is to allow for a longer travel distance which can depend on how close such a restrictor can be installed to the fulcrum point of the parking brake handle. The closer that it can be installed to that fulcrum, the shorter the travel distance needs to be.

This particular embodiment uses three tubes 96 and two actuators, which offers some flexibility with regards to the installation location along the length of handle 80.

When the parking brakes are disengaged, and handle 80 is at its lowest point, closest to console 82, telescopic restrictor 90 is compacted. The two actuator pins 52 are pulled back from their normal locking position. The actuator pins 52 are spring loaded 53 and will return into the orifices of tubes 96 once handle 80 is pulled back up. The two actuators 50 will lock tubes 96 at the desired dimension when handle 80 is pulled back up again in order to engage the parking brakes of the vehicle. Circuit 56 will communicate to the seat belt restrictor 40 to allow the driver access to the clip release button 34 and thus unfasten his/her seat belt.

### The Fourth Embodiment

### Detailed Description of the Fourth Embodiment

### The Parking Brake Restrictor Device of the Fourth Embodiment

FIGS. 19 through 21

### FIG. 19

FIG. 19 shows a close-up isometric drawing of a Release Button Restrictor Assembly 100. A handle grip 102 installs at handle 80. A flip-cap 104 is hinged 106 to handle grip 102. An actuator 50 is located at the area of hinge 106. An electrical wire 58 connects actuator 50 to the vehicle power source and an electrical communication loop circuit 56. Wiring 58 has a break line in this drawing indicating a length of travel from the front of handle 80 to the its back end at the fulcrum. An angle-monitoring contact 59 at the fulcrum is connected with wiring 58.

### FIG. 20

FIG. 20 shows an isometric drawing of Button Restrictor 100 installed on handle 80. Handle 80 is in a drawn-down position indicating that the parking brakes are disengaged. Wiring 58 runs along handle 80 from handle grip 102 down to angle-monitoring contact 59 situated at the fulcrum. Flip-cap 104 is opened and handle release button 84 is accessible. Actuator 50 is unlocked. Hinge 106 and console 82 complete the drawing.

### FIG. 21

FIG. 21 now shows handle 80 in a drawn-up position indicating that the parking brakes are engaged. Flip-cap 104 is now closed over handle release button 84. Actuator 50 at the area of hinge 106 is locked. Wiring 58 connects handle grip 102 to angle-monitoring contact 59. Console 82 completes the drawing.

### Operation of the Parking Brake Restrictor Device of the Fourth Embodiment

FIGS. 19 through 21

The operation of the fourth embodiment of the ‘Combination Parking Brake-Seat Belt Minder’ is exactly the same as that of the third embodiment except that the restrictive means is now being applied to handle release button 84 situated at the front end of handle 80 with the use of button restrictor. Whereas, telescopic restrictor 90 of the third embodiment restricted the up and down motion of handle 80, itself, button restrictor 100 accomplishes the same feat by restricting the driver's access to handle release button 84.

### A Demonstration

The driver gets in the vehicle and starts the motor. He/she reaches for handle 80 to press the handle release button 84 and soon realizes that he/she needs to fasten his/her seat belt first.

The button 84 of handle 80 is covered over by the button restrictor 100. Flip-cap 104 is locked over button 84 with actuator 50 situated in the area of hinge 106.

As soon as the driver's seat belt is fastened, flip-cap 104 is opened thus allowing the driver access to button 84 of the handle 80.

What allowed this to happen is that when the driver inserted seat belt clip 32 into seat belt buckle 30, a contact circuit 56 situated at the merge point of buckle 34 and clip 32 closes. This allows an electrical charge to enter circuit 56 connecting with actuator 50 at area of hinge 106 of flip-cap 104. As a result, actuator 50 unlocks flip-cap 104 and the driver can now open it and gain access to button 84 of handle 80.

He/she then pushes button 84 and draws down handle 80 in order to disengage the parking brakes and get the vehicle rolling.

Later on, when the driver wishes to get up off the driver's seat, and reaches for his/her seat belt clip release button 34, he/she soon realizes that before he/she can release his/her seat belt, he/she needs to apply the parking brakes of the vehicle. So the driver pulls up on handle 80 to engage the parking brakes.

This event causes the angle-monitoring contact 59 at the fulcrum to close thus allowing electrical charge into circuit 56. However, the driver also has to close flip-cap 104 over the handle release button 84 of handle 80. This event closes a contact at the area of hinge 106 of the button restrictor assembly 100, thus allowing electrical charge into circuit 56.

With both of these events being satisfied, circuit 56 sends current to actuator 50 at seat belt restrictor 40 causing actuator 50 to unlock thus giving the driver access to the seat belt clip release button 34 so that he/she can unfasten his/her seat belt.

Thus we can see that all of the aforementioned embodiments create an enhanced element of certainty in the execution of vehicle handling responsibilities which increase the safety and security of all the stakeholders. A driver will always be wearing their seat belt whenever the vehicle's parking brakes are disengaged, and the parking brakes will always be engaged whenever the driver gets up off of the driver's seat. Other enforcements may also be had if so desired by merely adding electrical contact circuitry to the objects pertaining to such desires.

### CONCLUSION, RAMIFICATIONS AND SCOPE

Thus the reader will see that at least one embodiment of the ‘Combination Parking Brake-Seat Belt Minder’ provides additional safety and security to the driving public and all of the other possible stakeholders.

The driver will become quite accustomed to reaching for the parking brake before unfastening his/her seat belt that it will be an automatic function, and as well, the driver will automatically fasten his/her seat belt. The driver will enjoy the peace of mind that comes from knowing that the parking brakes are certainly set.

The law enforcement people will enjoy the knowledge that any time a vehicle is moving, thanks to the means provided by these embodiments, the drivers are certainly wearing their seat belts and not using wireless technology while driving.

While my above description contains many specificities these should not be construed as limitations on the scope, but rather as an exemplification of several embodiments thereof. Many other variations are possible. Several more examples are outlined below.

### The Fifth Embodiment

The fifth embodiment is based on the notion that some people might prefer to have their parking brake knob, seat belt buckle, and/or the parking brake handle lever replaced entirely with the modifications of the electronic actuators and circuits built right into these replacement versions. These modified versions would look almost exactly like the items that they are replacing except for the electric wiring protruding from the devices and the restricting means of the embodiment causing a slight outward appearance variation on the design.

### The Sixth Embodiment

While all the former embodiments are trended towards the after-market, this sixth embodiment considers the new vehicle market with a ‘factory install’ version, whereby the electronic actuators and circuits for both the parking brake controls and the driver's seat belt may be installed at any convenient locale along the control chain system.

A likely place for the seat belt buckle is to have the actuator installed at an orifice created at the seat belt clip release button situated within the seat belt buckle.

The lever hand parking brake version can have the actuator installed at an orifice created at the handle release button within the parking brake lever handle.

The parking brake knob version can have the actuator installed at an orifice created at the airbrake stem behind the dashboard.

These are just a few of the likely examples of factory installation of the ‘Combination Parking Brake—Seat Belt Minder’

### Optional Overide Switch

There may be reason to need an optional override switch. With regards to all embodiments being offered, such a switch can be included that will allow the driver to bypass the controls of these embodiments but it would remain as an additional step for the driver to have to take and the system will always default in favor of the safety and security concerns that this invention satisfies.

### Optional Add-Ons to the Parking Brake Restriction Device

Here is a list of functions that may also be controlled by the aforementioned embodiments that can be offered as optional add-ons in the marketplace.

The parking brake restrictive means can also be employed to monitor the accepted vehicle starting method being the key in the ignition. An electronic communication circuit can be hooked up to the ignition switch connecting it to any of the parking brake restrictive control devices, thus assuring that the vehicle is being started by this accepted means otherwise the parking brakes will not disengage.

The parking brake restrictive means can also be employed to monitor a driver's sobriety status. An electronic communication circuit can be hooked up to a breathalyzer testing device and connecting with the parking brake restrictive control device and thus assuring that the driver is sober according to the legal limits otherwise the parking brakes will not disengage.

The parking brake restrictive means can also be employed to monitor a fingerprint reader or other identifying means such as a password register. An electronic communication circuit can be hooked up to such a device and connected with the parking brake restrictive control device and thus assuring that the driver is an accepted party otherwise the parking brakes will not disengage.

This embodiment would help a situation, for example, where many keys have been distributed and the owner of the vehicle can change passwords as often as needed to maintain control of vehicle usage.

The parking brake restrictive means can also be employed to disallow usage of cell phones and texting while driving through the use of a wireless scrambling means which must be engaged before the brakes will disengage.

As technological advancements bring up new possibilities, such as, for example, being able to determine a driver's drowsiness level, such events may also employ the monitoring benefits of the embodiments above.

### Optional Add-Ons to the Seat Belt Restriction Device

It might be possible that the marketplace might want to add the monitoring of battery draining electrical discharges caused by, for example, leaving the lights of the vehicle on, in that, the seat belt will not unfasten unless all the lights in the vehicle are off.

### Additional Option

Both the parking brake restrictive devises and the seat belt restrictive device can be made to work either in tandem with each other as I have shown above or the can work solo.

Accordingly, the scope should be determined not by the embodiments illustrated, but by the appended claims and their legal equivalents.

I claim:

1. A method for enhancing vehicular management safety and security, by providing:
a. a modified parking brake control mechanism, said modification being accomplished either with a modified replacement version of said parking brake, or by use of an external element that, having said modifications built in, can be affixed to the existing version of said parking brake within said vehicle
b. a modified seat belt buckle, said modification being accomplished either with a modified replacement version of said seat belt buckle or by use of an external element that, having said modifications built in, can be affixed to the existing version of said seat belt buckle within said vehicle
c. a means of communication and control between said seat belt, said parking brake and a plurality of other devices,
whereby, providing the benefits of a plurality of safety and security functions, by virtue of application of said provided modifications, such as, but not limited to, for example:
1. when said seat belt being buckled around a driver of said vehicle and through said communication with said parking brake, by permitting the unbuckling of said seat belt only after said parking brake is engaged thus assuring that said parking brake is applied whenever said vehicle is parked,
2. when said seat belt being buckled around said driver of said vehicle and through said communication with a battery monitoring means, by permitting the unbuckling of said seat belt only after all potential electrical battery drains are turned off,
3. when said parking brake and through communication with said seat belt, by permitting the disengagement of said parking brakes only after said seat belt is buckled around said driver thus assuring that said seat belt is being worn by said driver whenever said vehicle is in motion,
4. when said parking brake and through communication with a means for ignition protocol monitoring, by permitting disengagement of said parking brake only after said vehicle has been started with accepted ignition protocol thus providing anti-theft security enhancement,
5. when said parking brake and through communication with a means for sobriety testing for said driver, by permitting disengagement of said parking brake only after said testing indicates that said driver is sober,
6. when said parking brake and through communication with a means for identifying the properly authorized driver of said vehicle, by permitting disengagement of said parking brake only after a positive determination for said authorized driver has been established,
7. when said parking brake and through communication with a means for wireless inhibition capabilities, by permitting disengagement of said parking brake only after said wireless inhibition means has been engaged thus assuring that cell phone talking and texting usage cannot be done while vehicle is in motion.

2. A combination of two articles of manufacture for enhancing vehicular management safety and security, comprising:
a. a modified parking brake control mechanism, said modification being accomplished either with a modified replacement version of said parking brake, or by use of an external element that, having said modifications built in, can be affixed to the existing version of said parking brake within said vehicle
b. a modified seat belt buckle, said modification being accomplished either with a modified replacement version of said seat belt buckle or by use of an external element that, having said modifications built in, can be affixed to the existing version of said seat belt buckle within said vehicle
whereby, through a means of communication and control between said seat belt, said parking brake and a plurality of other devices, providing the benefits of a plurality of safety and security functions, by virtue of application of said provided modifications, such as, but not limited to, for example:
1. when said seat belt being buckled around a driver of said vehicle and through said communication with said parking brake, by permitting the unbuckling of said seat belt only after said parking brake is engaged thus assuring that said parking brake is applied whenever said vehicle is parked,
2. when said seat belt being buckled around said driver of said vehicle and through said communication with a battery monitoring means, by
3. permitting the unbuckling of said seat belt only after all potential electrical battery drains are turned off,
4. when said parking brake and through said communication with said seat belt, by permitting disengagement of said parking brake only after said seat belt is buckled around said driver thus assuring that said seat belt is being worn by said driver whenever said vehicle is in motion,
5. when said parking brake and through communication with a means for ignition protocol monitoring, by permitting disengagement of said parking brake only after said vehicle has been started with accepted ignition protocol thus providing anti-theft security enhancement,
6. when said parking brake and through communication with a means for sobriety testing for said driver, by permitting disengagement of said parking brake only after said testing indicates that said driver is sober,
7. when said parking brake and through communication with a means for identifying the properly authorized driver of said vehicle, by permitting disengagement of said parking brake only after a positive determination for said authorized driver has been established,
8. when said parking brake and through communication with a means for wireless inhibition capabilities, by permitting disengagement of said parking brake only after said wireless inhibition means has been engaged thus assuring that cell phone talking and texting usage cannot be done while vehicle is in motion.

3. The combination of two articles of manufacture of claim 2, said means of communication and control selected from a group of available methods, such as the conventional electronic apparatus currently being used in vehicles, and comprising of but not limited to:
a. contacts within an electrical loop for communication,
b. actuators or solenoids for physical restriction and release,
whereby allowing for a desired cause and effect relationship between said seat belt and said parking brake towards each other and towards said plurality of safety and security means.

4. The combination of two articles of manufacture of claim 2, said parking brake control mechanism, of which, a preferred embodiment chosen from group of available devices, being, a parking brake knob, as conventionally found in commercial vehicles, and which is handled by being; either pushed against the dashboard of said vehicle to disengage the parking brakes, or pulled away from said dashboard to engage said parking brakes, said modification being accomplished; either with a modified replacement version of said parking brake knob, or by use of an external element that, having the modifications built in, can be affixed to the existing version of said parking brake knob within said vehicle, wherein said external element that is affixed to said parking brake knob and designed to apply the said defined set of protocol is further elaborated as:
a. a means for controlling the usage of said parking brakes, a preferred embodiment being, a collapsible collar fitting around the neck of said existing parking brake knob,
b. said collapsible collar further comprising of an outer collar and an inner collar, said collapsible collar further comprising of said electronic apparatus, and which, by means of said electronic apparatus, and in communication with any one or plurality of said safety and security functions, said collapsible collar is locked in an extended position and prevented from collapsing, thus only allowing said driver being able to push said parking brake knob against said dashboard in order to disengage said parking brakes, when any one or plurality of said safety and security functions are realized,
c. by means of said electronic apparatus, thus reliant upon any of the said safety and security functions being met, said collapsible collar is allowed to collapse, whereby a release of an actuator located within said collapsible collar, allows said outer collar to slide over said inner collar as said driver pushes in said parking brake knob and thus disengages said parking brakes thereby allowing said vehicle to roll,
d. said collapsible collar contains a spring coil which compresses whenever said collar is allowed to collapse, and will cause said collar to expand back to said extended position once said driver pulls said parking brake knob back away from said dashboard, thus allowing said actuator within said collar to lock said collar in said extended position and this, in turn will communicate said parking brake current status to said safety and security functions.

5. The seat belt buckle of claim 2 wherein said external element that is affixed to said seat belt buckle and designed to apply the said defined set of protocol is further elaborated as:
a. a means for controlling the usage of said seat belt, the preferred embodiment being, a restrictive clamp,
b. said restrictive clamp comprising of, a box that is affixed to and encloses said seat belt buckle,
c. said restrictive clamp comprising of, a gate that is allowed to close over the release button of said existing seat belt buckle,
d. said restrictive clamp comprising of said electronic apparatus, and which, by means of said electronic apparatus, said restrictive clamp is wired to said parking brake modification for communication and control, by means of said electronic apparatus, in order for said driver to be able to disengage said parking brakes, said seat belt needs to be worn by said driver, and said gate needs to be closed and locked over said seat belt release button,
e. by means of said electronic apparatus, thus reliant upon the condition of said parking brake knob being pulled away from said dashboard thus indicating that parking brakes are engaged, a release of an actuator located within said restrictive clamp, allows said gate to open and provide said driver with access to said seat belt release button so that said driver may release said seat belt and exit said vehicle,
f. by means of said electronic apparatus, and if so desired, thus can also be made reliant upon the condition of communicating with said means for battery-drain detection which will indicate that no electrical battery drainage is occurring, allowing the release of an actuator located within said restrictive clamp, allowing said gate to open and provide said driver with access to said seat belt release button so that said driver may release said seat belt and exit said vehicle.

6. The combination of two articles of manufacture of claim 2, said parking brake control mechanism, of which, another embodiment chosen from group of available devices, being, a parking brake handle, as commonly found in passenger vehicles and pick-up trucks, whereby, a means for restriction and control is applied and made to communicate with said seat belt or other said safety and security function, using said electronic apparatus, using a telescopic device that is affixed to said handle at one end and to the floor of said vehicle at the other end, and is controlled according to desired said safety and security functions by allowing said telescopic to extend or not accordingly so.

7. The combination of two articles of manufacture of claim 2, said parking brake control mechanism, of which, another embodiment chosen from group of available devices, being, a parking brake handle, as commonly found in passenger vehicles and pick-up trucks, whereby, a means for restriction and control is applied and made to communicate with said seat belt or other said safety and security function, using said electronic apparatus, using a cap device that is affixed to said handle at the area opposite of the fulcrum, where the said driver uses the thumb of his/her hand to push the release button of said parking brake, and so said cap is used to restrict access to said button according to desired said safety and security functions by allowing said cap to open or close access to said release button accordingly so.

8. The combination of two articles of manufacture of claim 2, said parking brake control mechanism, of which, another embodiment chosen from group of available devices would be a means for said control mechanism which would be installed at the factory where said vehicle is manufactured, and may be installed anywhere along the chain of control of said parking brake function
